(19) United States
(12) Patent Application Publication
(10) Pub. No.: US 2014/0363885 A1
(43) Pub. Date: Dec. 11, 2014

(54) TEAR-AWAY MULTI WELL PLATE

(71) Applicant: 4titude Ltd., Wotton (GB)

(72) Inventors: Paul DAY, Dorking (GB); Peter Collins, Shamley Green (GB); Thomas Lernbecher, Reigate (GB)

(21) Appl. No.: 14/296,968

(22) Filed: Jun. 5, 2014

(30) Foreign Application Priority Data
Jun. 6, 2013 (EP) 13 17 0873.7

(51) Int. Cl. B01L 3/00; B26F 1/18; B26D 3/08

(52) U.S. Cl. CPC B01L 3/50855; B26D 3/085; B26F 1/18
USPC 435/305.2; 83/880; 83/846; 422/552

(57) ABSTRACT

The present invention relates to a method for producing a perforated breakable multi well plate comprising providing a multi well plate, and generating one or more perforated section lines along the width and/or length of the multi well plate by puncturing the multi well plate with a slotted blade for each section line to be generated, wherein the slotted blade is rigid and sharpened along one edge and a series of slots extends from the sharpened edge into the blade, thereby forming a series of sharp and rigid teeth alternating with slots. The invention further relates to a press tool usable in the above method as well as a perforated breakable multi well plate.

### FIELD OF THE INVENTION

The present invention relates to the field of disposables for laboratories, e.g. for chemical and biological laboratories. Particularly the invention provides a perforated breakable multi well plate. Furthermore, the invention relates to a method of production of said multi well plate as well as a tool usable in the production method.

### BACKGROUND

Various biological research and clinical diagnostic procedures and techniques require or are facilitated by an array of wells or tubes in which multiple samples are disposed for qualitative and quantitative assays or for sample storage and retrieval. Prior art devices that provide an array of wells or tubes capable of containing small sample volumes include multi well plates.

Multi well plates are especially useful in conjunction with automated thermocyclers for performing the widely used polymerase chain reaction (PCR) and for DNA cycle sequencing and the like. They are also highly useful for biological micro-culturing and assay procedures, and for performing chemical syntheses on a micro scale. Multi-well plates are most often used for relatively small scale laboratory procedures and are therefore also commonly known as “microplates”. Example multi-well plates are those disclosed in EP 0638364, GB 2288233, U.S. Pat. No. 3,907,505 and U.S. Pat. No. 4,968,625.

As many as 96 individual reactions can be simultaneously performed in a 96-well plate by placing said single multi well plate within a thermal cycler unit. Often, only s subset of said 96 wells is needed. So, there has been a requirement in multi well plates with a variable well number, which has been met by the provision of divisible multi well plates.

Divisible multi well plates comprise one or more section lines being provided in the plate portion in pre-determined regions, said section fines being adapted to facilitate dividing up the multi-well plate into sub-units of a pre-determined size, said section Ones comprising one or more apertures extending through the thickness of the plate portion. Divisible multi well plates are disclosed in EP 1 053 790 B1.

The inventors found that present divisible multi well plates suffer from several disadvantages. The inventors attribute the above disadvantages to the manufacturing process. Manufacturing is nowadays done by injection molding. The mold cavity comprises configurations for the final product which includes configurations for the section line. As for any molding process, dimensions are restricted. For example, a hole in a plastic product cannot he made arbitrarily small, because then a tiny pin would be required within the mold cavity, which will rapidly disintegrate upon re-use. Further, as the complexity of a molding tray increases, there is less complete molding. As a result, section lines cannot feature small perforations but must have rather big openings. The resulting multi well plate will be rather unstable. Alternatively, if one tried to make small section lines, the plate would break insufficiently due to incomplete molding. This is not the case for the herein described multi well plate produced by the herein described method.

Furthermore, the inventor found that the new multi well plate has superior breaking characteristics as compared with the present multi well plates, which means that there do not occur cracks anywhere else than within the section line. The new production method yields multi well plate with a very reproducible quality. A further advantage is that a multi well plate with a very narrow section line can be more efficiently sealed as the presently available plates.

### DESCRIPTION OF THE INVENTION

Production Method of the Multi Well Plate

The inventors found that an enhanced divisible multi well plate can be produced with a press method. Hence, the invention relates to a method for producing a perforated breakable multi well plate as described herein comprises a) providing a multi well plate, and b) generating one or more perforated section lines along the width and/or length of the multi well plate by puncturing the multi well plate with a slotted blade for each section line to be generated, wherein the slotted blade is rigid and sharpened along one edge and a series of slots extends from the sharpened edge into the blade, thereby forming a series of sharp and rigid teeth alternating with slots.

“Section line” herein denotes a predetermined breaking line which means that the multi well plate can easily be divided into sub-units. Easily means that the plate can be divided without an additional tool.

Providing a multi well plate means that the present method makes use of a cured multi well plate. From scratch, it would mean that first a multi well plate is produced and, then, after curing the section line is generated.

The production method makes use of a slotted blade specifically adapted for the herein described purpose. The slotted blade is described further below in the context of a press tool.

The section line generated may be additionally narrowed, which means that the thickness of the multi well plate is thinner at the perforated section line than around the perforated section line. Preferably the thickness of the multi well plate is 0.1-1 mm thick at the perforated section line, preferably 0.1-0.8 mm thick, more preferably 0.1-0.5 mm thick.

In a preferred embodiment, the section line is generated in a single step. This may mean that a single slotted blade is used for generating a section line comprising perforations and/or narrowed.

Tool for Producing the Multi Well Plate

The novel multi well plate can be produced with the aid of a new press tool which has been specifically adapted to pierce perforations into a cured multi well plate.

The press tool comprises a slotted blade, wherein the slotted blade is rigid and sharpened at one edge and a series of slots extends from the sharpened edge into the blade, thereby forming a series of sharp and rigid teeth alternating with slots.

“Rigid” herein means that the slotted blade qualifies as a press tool and can be repeatedly used without suffering from substantial deformation. As will be understood by the skilled person, rigidity depends on the dimensions and material of the blade. The definitions further below denote a rigid blade and rigid teeth within the meaning of the present application.

In some embodiments, the sharpened edge may be 0.01-0.2 mm thick at its tip, preferably 0.01-0.1 mm thick, more preferably 0.02-0.08 mm thick, most preferably 0.05 mm thick. In other embodiments, the sharpened edge may be 0.05-0.8 mm thick at its tip, preferably 0.1-0.5 mm thick, more preferably 0.2-0.4 mm thick. At its base, the sharpened edge may be 0.3-1.5 mm thick, preferably 0.5-1.0 mm, more preferably 0.6-0.8 mm, most preferably 0.7 mm thick.

The slotted blade may comprise 6-14 teeth, preferably 8-12 teeth, more preferably 9-11 teeth, most preferably 10 teeth or wherein the slotted blade comprises 1-9 teeth, preferably 3-9 teeth. The person skilled in the art will appreciate that only those teeth are relevant that are present in a row which does not exceed the width or the length of the multi well plate. This means only those teeth are counted above that actually participate in perforation. Furthermore, the skilled person will appreciate that the number of teeth depends on the width or length of the multi well plate to be perforated. The teeth have preferably a rectangular shape and rounded edges,

With respect to its length, the slotted blade may be 50-150 mm long, preferably 60-120 mm long, more preferably 85-130 mm long. As will be understood by the skilled person, the final length depends likewise on the format of the multi well plate.

in the press tool, the tooth may be between 1 and 30 mm long, preferably between 8 and 15 mm long, more preferably between 7 and 12 mm long, most preferably 9 mm long.

The tooth-to-tooth distance may be 0.1-10 mm, preferably 0.2-5 mm, more preferably 0.3-1 mm, most preferably 0.7 mm.

The slot between two adjacent teeth has preferably a rectangular shape. The slot may extend into the blade by 0.2-5 mm, preferably by 2 mm.

In a preferred embodiment, the slotted blade is made of carbide steel, tin coated carbide steel, or steel.

In a specific embodiment, the press tool comprises a slotted blade, wherein the slotted blade is rigid and sharpened at one edge and a series of slots extends from the sharpened edge into the blade, thereby forming a series of sharp and rigid teeth alternating with slots, wherein the slotted blade is at least 50-150 mm long, comprises 6-14 teeth of 5-20 mm in length, separated from each other by a slot of 0.1-10 mm extending into the blade by 0.2-2 mm, and optionally wherein the sharpened edge is characterized as above, e.g. wherein the sharpened edge is 0.01-0.2 mm or 0.02-0.5 mm thick at its tip and optionally wherein the sharpened edge is 0.3-1.5 mm thick at its base.

The press tool may comprise 3-25, preferably 3, 4, 5,. 7, 9, 11, 13, 15, 11 or 25 slotted blades, each slotted blade being spaced apart at a distance of 8 to 10 mm or 4 to 5 mm, more preferably 9 mm or 4.5 mm apart, and organized in a parallel arrangement.

The Multi Well Plate

The above production method provides a multi well plate with superior characteristics as outlined above. The present invention thus relates to a perforated breakable multi well plate comprising one or more perforated and optionally narrowed section lines along the width and/or length of the multi well plate separating the multi well plate into smaller plate portions or strips, wherein the section line leaves a gap of 0.02-1 mm between adjacent plate portions or strips at its narrowest point, preferably 0.05-0.2 mm, more preferably 0.08-0.12 mm, most preferably 0.1 mm and/or wherein the section line leaves a gap of 0.05-1.0 mm between adjacent plate portions or strips at its widest point, preferably 0.5-1.0 mm, more preferably 0.8-0.3 mm, most preferably 0.2 mm.

The section line may comprise 6-45, preferably 8-12, more preferably 9-11, most preferably 10 perforations, or wherein the section line comprises 8-18, more preferably 10-15, most preferably 13 perforations. The perforations preferably lie along a straight line in the frame portion and separate two adjacent columns or rows, in a preferred embodiment, the section line lies between each row and/or column of the multi well plate.

The perforation may be 1-20 mm, preferably 6-15 mm, more preferably 7-10 mm, most preferably 9 mm long. The length shall be understood to be measured along the section line in longitudinal direction.

The section line may comprise a bar between adjacent perforations. The bar is a connection between adjacent columns or rows. It is the material which is left over where the slotted blade has a slot. The bar may be between 0.1 and 10 mm, preferably between 0.2 and 5 mm, more preferably between 0.3 and 1 mm, most preferably 0.7 mm long. Again, the length shall be understood to be measured along the section line in longitudinal direction,

The thickness may be 0.05-1 mm at the perforated section line, preferably 0.2-0.8 mm, more preferably 0.3 mm. The thickness relate to the dimension of the cross-sectional diameter, preferably at the thinnest point, where there is still material left.

The multi well plate may be made of a polymer or filled polymer resin, preferably polypropylene, polyethylene or polycarbonate. It is further preferred that the multi well plate is made of a single material, for example of one of the materials mentioned above.

Most preferably, the multi well plate described herein is intended for PCR.

General Characteristics of the Multi Well Plate

For providing a multi well plate suited for the use in molecular techniques, the material has to withstand high temperatures and must have good properties for thermal transfer. Thus, in a preferred embodiment of the present invention the material is suited for PCR. with regard to its softening temperature and thermal diffusivity, The skilled person is aware of the requirements a material has to fulfill in order to be suited for PCR, in a preferred embodiment of the present invention the material can withstand a temperature of at least 60° C., preferably at least 95° C., more preferably at least 120° C., even more preferably 130° C.

“Thermal diffusivity” describes the ability of a material or substances to rapidly adjust their temperature to that of their surroundings and thereby transfer the temperature from one side of the material to another, because they conduct heat quickly in comparison to their volumetric heat capacity. The skilled person is aware of the possibilities to modify the thermal diffusivity of a material. One way of modifying the thermal diffusivity of a material is to choose different substances for the material. Materials which have the desired thermal diffusivity are known to those skilled in the art. In one preferred embodiment the material is selected from the group consisting of polypropylene (PR), polyethylene (PE) and polycarbonate (PC).

Particularly in PCR, them are seemingly counter acting requirements on the frame portion and the wells of a multi well plate. While the frame portion ideally provides for rigidity of the multi well plate for easy handling, the wells shall have a good thermal diffusivity in order to rapidly adjust to cycling temperatures. This trade-off can be met by a multi well plate which has different physical or chemical properties in the frame portion and wells. WO 2011/101487 A1, which is herewith incorporated by reference describes a multi well plate with a staffer frame portion than the wells. The different stiffness is achieved by different thicknesses of the same material or by different materials having different rigidity. For example, the frame portion is made of polycarbonate (PC), cycloolefin copolymer (COC; Topas™ COC), or cycloolefin polymer (COP) and the wells are made of polypropylene (PP). Further possible materials and combinations that are within the scope of the present invention are described in WO 2011/101487 A1.

The shape of the wells can be adjusted to the need of the procedures and methods the multi well plate is used in, e.g. for use in thermocyclers the wells have to be usually cup- or u-shaped or v-shaped, whereas for ELISA the wells are often flat bottomed. While further shapes may be possible, the above ones are preferred.

The skilled person will recognize that the advantages provided by the present invention are not limited to a specific format of the multi well plate. Nevertheless, in a preferred embodiment the multi well plate is designed for the use in common systems. These commonly used systems have standard dimensions for the measurements of multi well plates with respect to e.g. the distance between the wells, the dimensions and shape of the wells. The skilled person is aware of the standards, e.g. ANSI/SBS 4-2004, “Microplates Well Position” (http://www,sbsonline.com/msdc/pdf/ANSI_SBS_{—}4-2004.pdf). The standards govern various characteristics of a micro plate including well dimensions (e.g. diameter, spacing and depth). In a preferred embodiment the dimensions of the wells and/or the spacing of the wells therefore meet the standards of ANSI/SBS 1-2004 through ANSI/SBS 4-2004. In a further preferred embodiment the spacing of one well to another with respect to the center of the wells is selected from the group consisting of 9 mm, 4.5 mm and 2.25 mm. in a further embodiment the narrow sides and the broad sides of the multi well plate have a length ratio of 125 mm to 9 mm, in another embodiment 83 mm to 9 mm. In an even further embodiment the format is selected from the group of so called 24-well, 32-well, 48-well, 96-well, 384-well or 1536-well format, in particular the multi well plate has a pattern consisting of 12×8 or 18×24 or subunits thereof.

For the person skilled in the art it will he clear that also sub units of the multi well plate fail under the scope of the present invention. The multi well plate may be divided into fragments consisting of one or more columns or rows. Thus, the present invention is not limited to the number of rows or columns divided by section lines.

The person skilled in the art will recognize that the volume of the wells may be adapted to the desires of the assay the strip is used in. However, in one embodiment of the present invention each of the wells has a volume of 1 μL to 1000 μL, preferably 2 μL to 200 μL, more preferably 20 μL to 40 μL. In another embodiment each of the wells has a volume of 100 μL, in yet another embodiment a volume of 200 μL.

The multi well plate herein may be most preferably described as comprising a frame portion which has an essentially planar top surface having a plurality of holes extending through said top surface arranged in a rectangular pattern consisting of rows and columns, wherein the wells extend downwardly through the plurality of holes in the frame portion and are joined with the top surface of the frame portion so that the receiving portions of the wells are beneath the top surface and wherein the section lines lie within the frame portion.

The herein described multi well plate allows for an easy handling in manual and automatic applications. Thus the present invention also relates to the use of a multi well plate in research procedures and diagnostic techniques, preferably in manual research procedures and/or diagnostic techniques, more preferably in automated research procedures and/or diagnostic techniques.

In a further preferred embodiment the manual or automatic research procedure and/or diagnostic technique are selected from the group consisting of amplification of nucleic acids, PCR, ELISA, sequencing, high content screening, crystallography, melt curve determination, hybridization assays, in-vitro translation, in-vitro transcription, cell-culturing, enzymatic assays.

### FIGURE CAPTIONS

FIG. 1: Preferred dimensions and/or shape of the slotted blade (in mm).

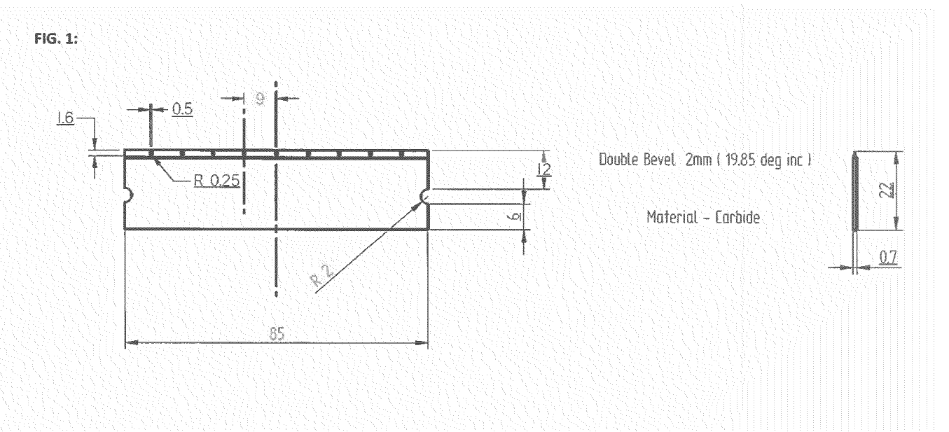

FIG 2: A preferred embodiment of the herein described multi well plate (top) as compared to a state of the art plate (bottom)

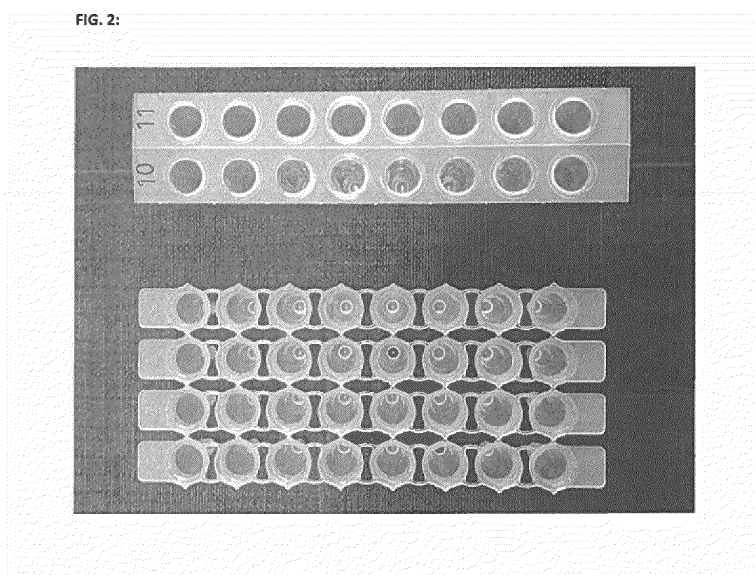

1. A method for producing a perforated breakable multi well plate comprising
a) providing a multi well plate, and
b) generating one or more perforated section lines along the width and/or length of the multi well plate by puncturing the multi well plate with a slotted blade for each section line to be generated,
wherein the slotted blade is rigid and sharpened along one edge and a series of slots extends from the sharpened edge into the blade, thereby forming a series of sharp and rigid teeth alternating with slots.

2. The method of claim 1, wherein the thickness of the multi well plate is thinner at the perforated section line than around the perforated section line.

3. The method of claim 1, wherein the section line is generated in a single step.

4. The method of a claim 1, wherein the slotted blade comprises 6-14 teeth or 1-9 teeth.

5. The method of claim 1 wherein the tooth is between 1 and 30 mm long.

6. The method of claim 1, wherein the slot separate adjacent teeth by between 0.1 and 10 mm.

7. The method of claim, 1, wherein the slot extends into the blade by 0.2-5 mm.

8. The method of claim 1, wherein the slotted blade is made of carbide steel, tin coated carbide steel, or steel.

9. A perforated breakable multi well plate comprising one or more perforated and optionally narrowed section lines along the width and/or length of the multi well plate separating the multi well plate into smaller plate portions or strips, wherein the section line leaves a gap of 0.02-1 mm between adjacent plate portions or strips at its narrowest point and/or wherein the section line leaves a gap of 0.05-1.0 mm between adjacent plate portions or strips at its widest point.

10. The perforated breakable multi well plate of claim 9, wherein the section line comprises 6-45 perforations, or wherein the section line comprises 8-18 perforations.

11. The perforated breakable multi well plate of claim 9, wherein the perforation is 1-20 mm long.

12. The method of claim 1, wherein the multi well plate is for PCR.

13. The method of claim 1, wherein the multi well plate has a pattern consisting of 12 ×8 or 16×24 or subunits thereof.

14. A press tool comprising a slotted blade, wherein the slotted blade is rigid and sharpened at one edge and a series of slots extends from the sharpened edge into the blade, thereby forming a series of sharp and rigid teeth alternating with slots, wherein the slotted blade is at least 50-150 mm long, comprises 6-14 teeth of 5-20 mm in length, separated from each other by a slot of 0.1-10 mm extending into the blade by 0.2-2 mm, and optionally wherein the sharpened edge is 0.01-0.2 mm or 0.02-0.5 mm thick at its tip and optionally wherein the sharpened edge is 0.3-1.5 mm thick at its base.

15. The press tool comprising 3-25 slotted blades as defined in claim 14 each slotted blade being spaced apart at a distance of 8-10 mm or 4-5 stub and organized in a parallel arrangement.

16. The perforated breakable multi well plate of claim 9, wherein the multi well plate is for PCR.

17. The perforated breakable multi well plate of claim 9, wherein the multi well plate has a pattern consisting of 12×8 or 16×24 or subunits thereof.
